(19) United States
(12) Patent Application Publication
(10) Pub. No.: US 2009/0210491 A1
(43) Pub. Date: Aug. 20, 2009

(54) TECHNIQUES TO AUTOMATICALLY IDENTIFY PARTICIPANTS FOR A MULTIMEDIA CONFERENCE EVENT

(75) Inventors: Pulin Thakkar, Redmond, WA (US); Quinn Hawkins, Kirkland, WA (US); Kapil Sharma, Woodinville, WA (US); Avronil Bhattacharjee, Redmond, WA (US); Ross G. Cutler, Redmond, WA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 12/033,894

(22) Filed: Feb. 20, 2008

(51) Int. Cl. G06F 15/16

(52) U.S. Cl. 709/204

(57) ABSTRACT

Techniques to automatically identify participants for a multimedia conference event are described. An apparatus may comprise a content-based annotation component operative to receive a meeting invitee list for a multimedia conference event. The content-based annotation component may receive multiple input media streams from multiple meeting consoles. The content-based annotation component may annotate media frames of each input media stream with identifying information for each participant within each input media stream to form a corresponding annotated media stream. Other embodiments are described and claimed.

### BACKGROUND

A multimedia conferencing system typically allows multiple participants to communicate and share different types of media content in a collaborative and real-time meeting over a network. The multimedia conferencing system may display different types of media content using various graphic user interface (GUI) windows or views. For example, one GUI view might include video images of participants, another GUI view might include presentation slides, yet another GUI view might include text messages between participants, and so forth. In this manner various geographically disparate participants may interact and communicate information in a virtual meeting environment similar to a physical meeting environment where all the participants are within one room.

In a virtual meeting environment, however, it may be difficult to identify the various participants of a meeting. This problem typically increases as the number of meeting participants increase, thereby potentially leading to confusion and awkwardness among the participants. Techniques directed to improving identification techniques in a virtual meeting environment may enhance user experience and convenience.

### SUMMARY

Various embodiments may be generally directed to multimedia conference systems. Some embodiments may be particularly directed to techniques to automatically identify participants for a multimedia conference event. The multimedia conference event may include multiple participants, some of which may gather in a conference room, while others may participate in the multimedia conference event from a remote location.

In one embodiment, for example, an apparatus may comprise a content-based annotation component operative to receive a meeting invitee list for a multimedia conference event. The content-based annotation component may receive multiple input media streams from multiple meeting consoles. The content-based annotation component may annotate media frames of each input media stream with identifying information for each participant within each input media stream to form a corresponding annotated media stream. Other embodiments are described and claimed.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 illustrates an embodiment of a multimedia conferencing system.

FIG. 2 illustrates an embodiment of a content-based annotation component.

FIG. 3 illustrates an embodiment of a multimedia conferencing server.

FIG. 4 illustrates an embodiment of a logic flow.

FIG. 5 illustrates an embodiment of a computing architecture.

FIG. 6 illustrates an embodiment of an article.

### DETAILED DESCRIPTION

Various embodiments include physical or logical structures arranged to perform certain operations, functions or services. The structures may comprise physical structures, logical structures or a combination of both. The physical or logical structures are implemented using hardware elements, software elements, or a combination of both. Descriptions of embodiments with reference to particular hardware or software elements, however, are meant as examples and not limitations. Decisions to use hardware or software elements to actually practice an embodiment depends on a number of external factors, such as desired computational rate, power levels, heat tolerances, processing cycle budget, input data rates, output data rates, memory resources, data bus speeds, and other design or performance constraints. Furthermore, the physical or logical structures may have corresponding physical or logical connections to communicate information between the structures in the form of electronic signals or messages. The connections may comprise wired and/or wireless connections as appropriate for the information or particular structure. It is worthy to note that any reference to “one embodiment” or “an embodiment” means that a particular feature, structure, or characteristic described in connection with the embodiment is included in at least one embodiment. The appearances of the phrase “in one embodiment” in various places in the specification are not necessarily all referring to the same embodiment.

Various embodiments may be generally directed to multimedia conferencing systems arranged to provide meeting and collaboration services to multiple participants over a network. Some multimedia conferencing systems may be designed to operate with various packet-based networks, such as the Internet or World Wide Web (“web”), to provide web-based conferencing services. Such implementations are sometimes referred to as web conferencing systems. An example of a web conferencing system may include MICROSOFT® OFFICE LIVE MEETING made by Microsoft Corporation, Redmond, Wash. Other multimedia conferencing systems may be designed to operate for a private network, business, organization, or enterprise, and may utilize a multimedia conferencing server such as MICROSOFT OFFICE COMMUNICATIONS SERVER made by Microsoft Corporation, Redmond, Wash. It may be appreciated, however, that implementations are not limited to these examples.

A multimedia conferencing system may include, among other network elements, a multimedia conferencing server or other processing device arranged to provide web conferencing services. For example, a multimedia conferencing server may include, among other server elements, a server meeting component operative to control and mix different types of media content for a meeting and collaboration event, such as a web conference. A meeting and collaboration event may refer to any multimedia conference event offering various types of multimedia information in a real-time or live online environment, and is sometimes referred to herein as simply a “meeting event,” “multimedia event” or “multimedia conference event.”

In one embodiment, the multimedia conferencing system may further include one or more computing devices implemented as meeting consoles. Each meeting console may be arranged to participate in a multimedia event by connecting to the multimedia conference server. Different types of media information from the various meeting consoles may be received by the multimedia conference server during the multimedia event, which in turn distributes the media information to some or all of the other meeting consoles participating in the multimedia event As such, any given meeting console may have a display with multiple media content views of different types of media content. In this manner various geographically disparate participants may interact and communicate information in a virtual meeting environment similar to a physical meeting environment where all the participants are within one room.

In a virtual meeting environment, it may be difficult to identify the various participants of a meeting. Participants in a multimedia conference event are typically listed in a GUI view with a participant roster. The participant roster may have some identifying information for each participant, including a name, location, image, title, and so forth. The participants and identifying information for the participant roster, however, is typically derived from a meeting console used to join the multimedia conference event. For example, a participant typically uses a meeting console to join a virtual meeting room for a multimedia conference event. Prior to joining, the participant provides various types of identifying information to perform authentication operations with the multimedia conferencing server. Once the multimedia conferencing server authenticates the participant, the participant is allowed access to the virtual meeting room, and the multimedia conferencing server adds the identifying information to the participant roster. In some cases, however, multiple participants may gather in a conference room and share various types of multimedia equipment coupled to a local meeting console to communicate with other participants having remote meeting consoles. Since there is a single local meeting console, a single participant in the conference room typically uses the local meeting console to join a multimedia conference event on behalf of all the participants in the conference room. In many cases, the participant using the local meeting console may not necessarily be registered to the local meeting console. Consequently, the multimedia conferencing server may not have any identifying information for any of the participants in the conference room, and therefore cannot update the participant roster.

The conference room scenario poses further problems for identification of participants. The participant roster and corresponding identifying information for each participant is typically shown in a separate GUI view from the other GUI views with multimedia content. There is no direct mapping between a participant from the participant roster and an image of the participant in the steaming video content. Consequently, when video content for the conference room contains images for multiple participants in the conference room, it becomes difficult to map a participant and identifying information with a participant in the video content.

To solve these and other problems, some embodiments are directed to techniques to automatically identify participants for a multimedia conference event. More particularly, certain embodiments are directed to techniques to automatically identify multiple participants in video content recorded from a conference room. In one embodiment, for example, an apparatus such as a multimedia conferencing server may comprise a content-based annotation component operative to receive a meeting invitee list for a multimedia conference event. The content-based annotation component may receive multiple input media streams from multiple meeting consoles, one of which may originate from a local meeting console in a conference room. The content-based annotation component may annotate media frames of each input media stream with identifying information for each participant within each input media stream to form a corresponding annotated media stream. The content-based annotation component may annotate, locate or position the identifying information in close proximity to the participant in the video content, and move the identifying information as the participant moves within the video content. In this manner, the automatic identification technique can allow participants for a multimedia conference event to more easily identify each other in a virtual meeting room. As a result, the automatic identification technique can improve affordability, scalability, modularity, extendibility, or interoperability for an operator, device or network.

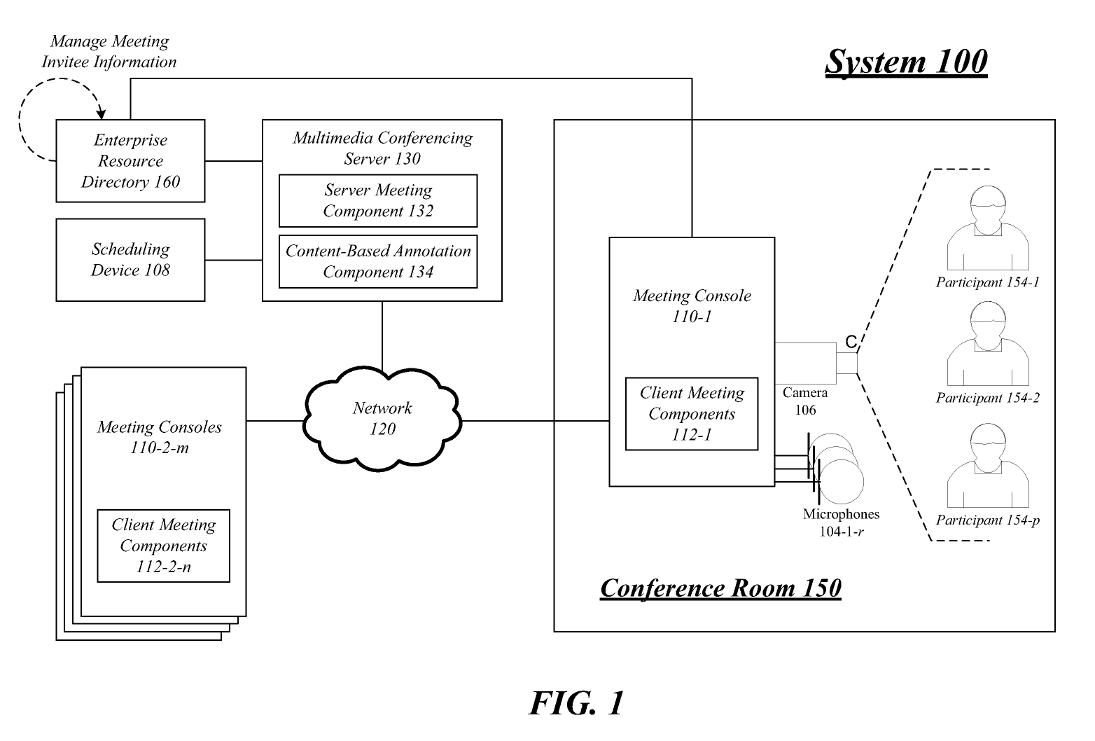

FIG. 1 illustrates a block diagram for a multimedia conferencing system 100. Multimedia conferencing system 100 may represent a general system architecture suitable for implementing various embodiments. Multimedia conferencing system 100 may comprise multiple elements. An element may comprise any physical or logical structure arranged to perform certain operations. Each element may be implemented as hardware, software, or any combination thereof, as desired for a given set of design parameters or performance constraints. Examples of hardware elements may include devices, components, processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), memory units, logic gates, registers, semiconductor device, chips, microchips, chip sets, and so forth. Examples of software may include any software components, programs, applications, computer programs, application programs, system programs, machine programs, operating system software, middleware, firmware, software modules, routines, subroutines, functions, methods, interfaces, software interfaces, application program interfaces (API), instruction sets, computing code, computer code, code segments, computer code segments, words, values, symbols, or any combination thereof. Although multimedia conferencing system 100 as shown in FIG. 1 has a limited number of elements in a certain topology, it may be appreciated that multimedia conferencing system 100 may include more or less elements in alternate topologies as desired for a given implementation. The embodiments are not limited in this context.

In various embodiments, the multimedia conferencing system 100 may comprise, or form part of, a wired communications system, a wireless communications system, or a combination of both. For example, the multimedia conferencing system 100 may include one or more elements arranged to communicate information over one or more types of wired communications links. Examples of a wired communications link may include, without limitation, a wire, cable, bus, printed circuit board (PCB), Ethernet connection, peer-to-peer (P2P) connection, backplane, switch fabric, semiconductor material, twisted-pair wire, co-axial cable, fiber optic connection, and so forth. The multimedia conferencing system 100 also may include one or more elements arranged to communicate information over one or more types of wireless communications links. Examples of a wireless communications link may include, without limitation, a radio channel, infrared channel, radio-frequency (RF) channel, Wireless Fidelity (WiFi) channel, a portion of the RF spectrum, and/or one or more licensed or license-free frequency bands.

In various embodiments, the multimedia conferencing system 100 may be arranged to communicate, manage or process different types of information, such as media information and control information. Examples of media information may generally include any data representing content meant for a user, such as voice information, video information, audio information, image information, textual information, numerical information, application information, alphanumeric symbols, graphics, and so forth. Media information may sometimes be referred to as “media content” as well. Control information may refer to any data representing commands, instructions or control words meant for an automated system. For example, control information may be used to route media information through a system, to establish a connection between devices, instruct a device to process the media information in a predetermined manner, and so forth.

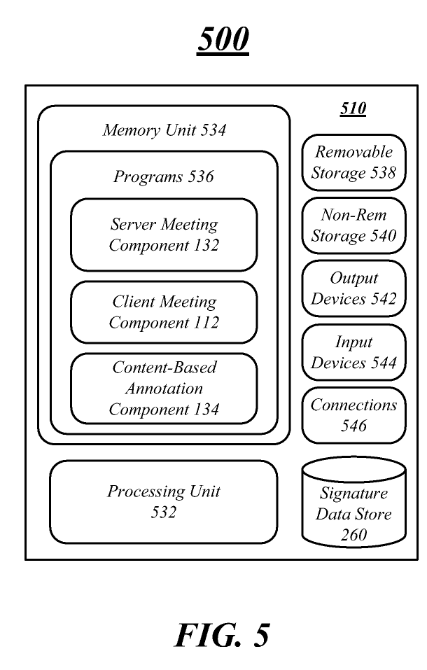

In various embodiments, multimedia conferencing system 100 may include a multimedia conferencing server 130. The multimedia conferencing server 130 may comprise any logical or physical entity that is arranged to establish, manage or control a multimedia conference call between meeting consoles 110-1-m over a network 120. Network 120 may comprise, for example, a packet-switched network, a circuit-switched network, or a combination of both. In various embodiments, the multimedia conferencing server 130 may comprise or be implemented as any processing or computing device, such as a computer, a server, a server array or server farm, a work station, a mini-computer, a main frame computer, a supercomputer, and so forth. The multimedia conferencing server 130 may comprise or implement a general or specific computing architecture suitable for communicating and processing multimedia information. In one embodiment, for example, the multimedia conferencing server 130 may be implemented using a computing architecture as described with reference to FIG. 5. Examples for the multimedia conferencing server 130 may include without limitation a MICROSOFT OFFICE COMMUNICATIONS SERVER, a MICROSOFT OFFICE LIVE MEETING server, and so forth.

A specific implementation for the multimedia conferencing server 130 may vary depending upon a set of communication protocols or standards to be used for the multimedia conferencing server 130. In one example, the multimedia conferencing server 130 may be implemented in accordance with the Internet Engineering Task Force (IETF) Multiparty Multimedia Session Control (MMUSIC) Working Group Session Initiation Protocol (SIP) series of standards and/or variants. SIP is a proposed standard for initiating, modifying, and terminating an interactive user session that involves multimedia elements such as video, voice, instant messaging, online games, and virtual reality. In another example, the multimedia conferencing server 130 may be implemented in accordance with the International Telecommunication Union (ITU) H.323 series of standards and/or variants. The H.323 standard defines a multipoint control unit (MCU) to coordinate conference call operations. In particular, the MCU includes a multipoint controller (MC) that handles H.245 signaling, and one or more multipoint processors (MP) to mix and process the data streams. Both the SIP and H.323 standards are essentially signaling protocols for Voice over Internet Protocol (VoIP) or Voice Over Packet (VOP) multimedia conference call operations. It may be appreciated that other signaling protocols may be implemented for the multimedia conferencing server 130, however, and still fall within the scope of the embodiments.

In general operation, multimedia conferencing system 100 may be used for multimedia conferencing calls. Multimedia conferencing calls typically involve communicating voice, video, and/or data information between multiple end points. For example, a public or private packet network 120 may be used for audio conferencing calls, video conferencing calls, audio/video conferencing calls, collaborative document sharing and editing, and so forth. The packet network 120 may also be connected to a Public Switched Telephone Network (PSTN) via one or more suitable VoIP gateways arranged to convert between circuit-switched information and packet information.

To establish a multimedia conferencing call over the packet network 120, each meeting console 110-1-m may connect to multimedia conferencing server 130 via the packet network 120 using various types of wired or wireless communications links operating at varying connection speeds or bandwidths, such as a lower bandwidth PSTN telephone connection, a medium bandwidth DSL modem connection or cable modem connection, and a higher bandwidth intranet connection over a local area network (LAN), for example.

In various embodiments, the multimedia conferencing server 130 may establish, manage and control a multimedia conference call between meeting consoles 110-1-m. In some embodiments, the multimedia conference call may comprise a live web-based conference call using a web conferencing application that provides full collaboration capabilities. The multimedia conferencing server 130 operates as a central server that controls and distributes media information in the conference. It receives media information from various meeting consoles 110-1-m, performs mixing operations for the multiple types of media information, and forwards the media information to some or all of the other participants. One or more of the meeting consoles 110-1-m may join a conference by connecting to the multimedia conferencing server 130. The multimedia conferencing server 130 may implement various admission control techniques to authenticate and add meeting consoles 110-1-m in a secure and controlled manner.

In various embodiments, the multimedia conferencing system 100 may include one or more computing devices implemented as meeting consoles 110-1-m to connect to the multimedia conferencing server 130 over one or more communications connections via the network 120. For example, a computing device may implement a client application that may host multiple meeting consoles each representing a separate conference at the same time. Similarly, the client application may receive multiple audio, video and data streams. For example, video streams from all or a subset of the participants may be displayed as a mosaic on the participant's display with a top window with video for the current active speaker, and a panoramic view of the other participants in other windows.

The meeting consoles 110-1-m may comprise any logical or physical entity that is arranged to participate or engage in a multimedia conferencing call managed by the multimedia conferencing server 130. The meeting consoles 110-1-m may be implemented as any device that includes, in its most basic form, a processing system including a processor and memory, one or more multimedia input/output (I/O) components, and a wireless and/or wired network connection. Examples of multimedia I/O components may include audio I/O components (e.g., microphones, speakers), video I/O components (e.g., video camera, display), tactile (I/O) components (e.g., vibrators), user data (I/O) components (e.g., keyboard, thumb board, keypad, touch screen), and so forth. Examples of the meeting consoles 110-1-m may include a telephone, a VoIP or VOP telephone, a packet telephone designed to operate on the PSTN, an Internet telephone, a video telephone, a cellular telephone, a personal digital assistant (PDA), a combination cellular telephone and PDA, a mobile computing device, a smart phone, a one-way pager, a two-way pager, a messaging device, a computer, a personal computer (PC), a desktop computer, a laptop computer, a notebook computer, a handheld computer, a network appliance, and so forth. In some implementations, the meeting consoles 110-1-m may be implemented using a general or specific computing architecture similar to the computing architecture described with reference to FIG. 5.

The meeting consoles 110-1-m may comprise or implement respective client meeting components 112-1-n. The client meeting components 112-1-n may be designed to interoperate with the server meeting component 132 of the multimedia conferencing server 130 to establish, manage or control a multimedia conferencing event. For example, the client meeting components 112-1-n may comprise or implement the appropriate application programs and user interface controls to allow the respective meeting consoles 110-1-m to participate in a web conference facilitated by the multimedia conferencing server 130. This may include input equipment (e.g., video camera, microphone, keyboard, mouse, controller, etc.) to capture media information provided by the operator of a meeting console 110-1-m, and output equipment (e.g., display, speaker, etc.) to reproduce media information by the operators of other meeting consoles 110-1-m. Examples for client meeting components 112-1-n may include without limitation a MICROSOFT OFFICE COMMUNICATOR or the MICROSOFT OFFICE LIVE MEETING Windows Based Meeting Console, and so forth.

As shown in the illustrated embodiment of FIG. 1, the multimedia conference system 100 may include a conference room 150. An enterprise or business typically utilizes conference rooms to hold meetings. Such meetings include multimedia conference events having participants located internal to the conference room 150, and remote participants located external to the conference room 150. The conference room 150 may have various computing and communications resources available to support multimedia conference events, and provide multimedia information between one or more remote meeting consoles 110-2-m and the local meeting console 110-1. For example, the conference room 150 may include a local meeting console 110-1 located internal to the conference room 150.

The local meeting console 110-1 may be connected to various multimedia input devices and/or multimedia output devices capable of capturing, communicating or reproducing multimedia information. The multimedia input devices may comprise any logical or physical device arranged to capture or receive as input multimedia information from operators within the conference room 150, including audio input devices, video input devices, image input devices, text input devices, and other multimedia input equipment. Examples of multimedia input devices may include without limitation video cameras, microphones, microphone arrays, conference telephones, whiteboards, interactive whiteboards, voice-to-text components, text-to-voice components, voice recognition systems, pointing devices, keyboards, touchscreens, tablet computers, handwriting recognition devices, and so forth. An example of a video camera may include a ringcam, such as the MICROSOFT ROUNDTABLE made by Microsoft Corporation, Redmond, Wash. The MICROSOFT ROUNDTABLE is a videoconferencing device with a 360 degree camera that provides remote meeting participants a panoramic video of everyone sitting around a conference table. The multimedia output devices may comprise any logical or physical device arranged to reproduce or display as output multimedia information from operators of the remote meeting consoles 110-2-m, including audio output devices, video output devices, image output devices, text input devices, and other multimedia output equipment. Examples of multimedia output devices may include without limitation electronic displays, video projectors, speakers, vibrating units, printers, facsimile machines, and so forth.

The local meeting console 110-1 in the conference room 150 may include various multimedia input devices arranged to capture media content from the conference room 150 including the participants 154-1-p, and stream the media content to the multimedia conferencing server 130. In the illustrated embodiment shown in FIG. 1, the local meeting console 110-1 includes a video camera 106 and an array of microphones 104-1-r. The video camera 106 may capture video content including video content of the participants 154-1-p present in the conference room 150, and stream the video content to the multimedia conferencing server 130 via the local meeting console 110-1. Similarly, the array of microphones 104-1-r may capture audio content including audio content from the participants 154-1-p present in the conference room 150, and stream the audio content to the multimedia conferencing server 130 via the local meeting console 110-1. The local meeting console may also include various media output devices, such as a display or video projector, to show one or more GUI views with video content or audio content from other participants using remote meeting consoles 110-2-m received via the multimedia conferencing server 130.

The meeting consoles 110-1-m and the multimedia conferencing server 130 may communicate media information and control information utilizing various media connections established for a given multimedia conference event. The media connections may be established using various VoIP signaling protocols, such as the SIP series of protocols. The SIP series of protocols are application-layer control (signaling) protocol for creating, modifying and terminating sessions with one or more participants. These sessions include Internet multimedia conferences, Internet telephone calls and multimedia distribution. Members in a session can communicate via multicast or via a mesh of unicast relations, or a combination of these. SIP is designed as part of the overall IETF multimedia data and control architecture currently incorporating protocols such as the resource reservation protocol (RSVP) (IEEE RFC 2205) for reserving network resources, the real-time transport protocol (RTP) (IEEE RFC 1889) for transporting real-time data and providing Quality-of-Service (QOS) feedback, the real-time streaming protocol (RTSP) (IEEE RFC 2326) for controlling delivery of streaming media, the session announcement protocol (SAP) for advertising multimedia sessions via multicast, the session description protocol (SDP) (IEEE RFC 2327) for describing multimedia sessions, and others. For example, the meeting consoles 110-1-m may use SIP as a signaling channel to setup the media connections, and RTP as a media channel to transport media information over the media connections.

In general operation, a schedule device 108 may be used to generate a multimedia conference event reservation for the multimedia conferencing system 100. The scheduling device 108 may comprise, for example, a computing device having the appropriate hardware and software for scheduling multimedia conference events. For example, the scheduling device 108 may comprise a computer utilizing MICROSOFT OFFICE OUTLOOK® application software, made by Microsoft Corporation, Redmond, Wash. The MICROSOFT OFFICE OUTLOOK application software comprises messaging and collaboration client software that may be used to schedule a multimedia conference event. An operator may use MICROSOFT OFFICE OUTLOOK to convert a schedule request to a MICROSOFT OFFICE LIVE MEETING event that is sent to a list of meeting invitees. The schedule request may include a hyperlink to a virtual room for a multimedia conference event. An invitee may click on the hyperlink, and the meeting console 110-1-m launches a web browser, connects to the multimedia conferencing server 130, and joins the virtual room. Once there, the participants can present a slide presentation, annotate documents or brainstorm on the built in whiteboard, among other tools.

An operator may use the scheduling device 108 to generate a multimedia conference event reservation for a multimedia conference event. The multimedia conference event reservation may include a list of meeting invitees for the multimedia conference event. The meeting invitee list may comprise a list of individuals invited to a multimedia conference event. In some cases, the meeting invitee list may only include those individuals invited and accepted for the multimedia event. A client application, such as a mail client for Microsoft Outlook, forwards the reservation request to the multimedia conferencing server 130. The multimedia conferencing server 130 may receive the multimedia conference event reservation, and retrieve the list of meeting invitees and associated information for the meeting invitees from a network device, such as an enterprise resource directory 160.

The enterprise resource directory 160 may comprise a network device that publishes a public directory of operators and/or network resources. A common example of network resources published by the enterprise resource directory 160 includes network printers. In one embodiment, for example, the enterprise resource directory 160 may be implemented as a MICROSOFT ACTIVE DIRECTORY®. Active Directory is an implementation of lightweight directory access protocol (LDAP) directory services to provide central authentication and authorization services for network computers. Active Directory also allows administrators to assign policies, deploy software, and apply critical updates to an organization. Active Directory stores information and settings in a central database. Active Directory networks can vary from a small installation with a few hundred objects, to a large installation with millions of objects.

In various embodiments, the enterprise resource directory 160 may include identifying information for the various meeting invitees to a multimedia conference event. The identifying information may include any type of information capable of uniquely identifying each of the meeting invitees. For example, the identifying information may include without limitation a name, a location, contact information, account numbers, professional information, organizational information (e.g., a title), personal information, connection information, presence information, a network address, a media access control (MAC) address, an Internet Protocol (IP) address, a telephone number, an email address, a protocol address (e.g., SIP address), equipment identifiers, hardware configurations, software configurations, wired interfaces, wireless interfaces, supported protocols, and other desired information.

The multimedia conferencing server 130 may receive the multimedia conference event reservation, including the list of meeting invitees, and retrieves the corresponding identifying information from the enterprise resource directory 160. The multimedia conferencing server 130 may use the list of meeting invitees to assist in automatically identifying the participants to a multimedia conference event.

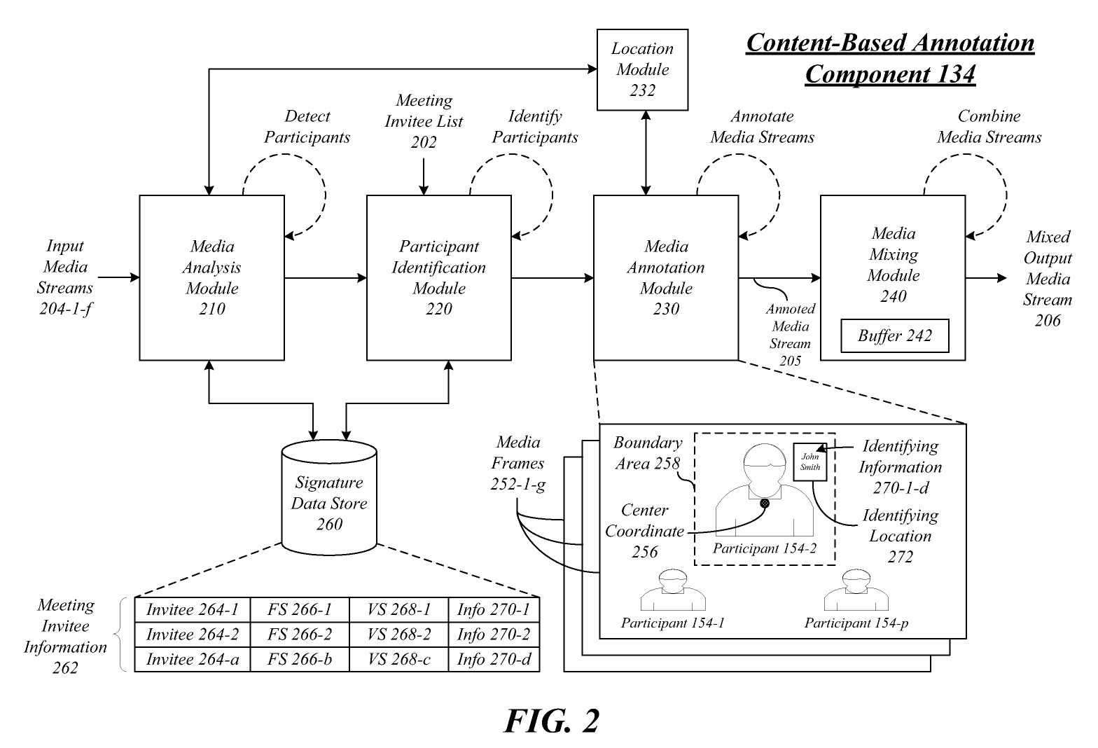

The multimedia conferencing server 130 may implement various hardware and/or software components to automatically identify the participants to a multimedia conference event. More particularly, the multimedia conferencing server 130 may implement techniques to automatically identify multiple participants in video content recorded from a conference room, such as the participants 154-1-p in the conference room 150. In the illustrated embodiment shown in FIG. 1, for example, the multimedia conferencing server 130 includes a content-based media annotation module 134. The content-based annotation component 134 may be arranged to receive a meeting invitee list for a multimedia conference event from the enterprise resource directory 160. The content-based annotation component 134 may also receive multiple input media streams from multiple meeting consoles 110-1-m, one of which may originate from the local meeting console 110-1 in the conference room 150. The content-based annotation component 134 may annotate one or more media frames of each input media stream with identifying information for each participant within each input media stream to form a corresponding annotated media stream. For example, the content-based annotation component 134 may annotate one or more media frames of the input media stream received from the local meeting console 110-1 with identifying information for each participant 154-1-p within the input media stream to form a corresponding annotated media stream. The content-based annotation component 154-1-p may annotate, locate or position the identifying information in relative close proximity to the participants 154-1-p in the input media stream, and move the identifying information as the participant 154-1-p moves within the input media stream. The content-based annotation component 134 may be described in more detail with reference to FIG. 2.

FIG. 2 illustrates a block diagram for the content-based annotation component 134. The content-based annotation component 134 may comprise a part or sub-system of the multimedia conferencing server 130. The content-based annotation component 134 may comprise multiple modules. The modules may be implemented using hardware elements, software elements, or a combination of hardware elements and software elements. Although the content-based annotation component 134 as shown in FIG. 2 has a limited number of elements in a certain topology, it may be appreciated that the content-based annotation component 134 may include more or less elements in alternate topologies as desired for a given implementation. The embodiments are not limited in this context.

In the illustrated embodiment shown in FIG. 2, the content-based annotation component 134 may comprise a media analysis module 210 communicatively coupled to a participant identification module 220 and a signature data store 260. The signature data store 260 may store various types of meeting invitee information 262. The participant identification module 220 is communicatively coupled to a media annotation module 230 and the signature data store 260. The media annotation module 230 is communicatively coupled to a media mixing module 240 and a location module 232. The location module 232 is communicatively coupled to the media analysis module 210. The media mixing module 240 may include one or more buffers 242.

The media analysis module 210 of the content-based annotation component 134 may be arranged to receive as input various input media streams 204-1-f. The input media streams 204-1-f may each comprise a stream of media content supported by the meeting consoles 110-1-m and the multimedia conferencing server 130. For example, a first input media stream may represent a video and/or audio stream from a remote meeting console 110-2-m. The first input media stream may comprise video content containing only a single participant using the meeting console 110-2-m. A second input media stream 204-2 may represent a video stream from a video camera such as camera 106 and an audio stream from one or more microphones 104-1-r coupled to the local meeting console 110-1. The second input media stream 204-2 may comprise video content containing the multiple participants 154-1-p using the local meeting console 110-1. Other input media streams 204-3-f may have varying combinations of media content (e.g., audio, video or data) with varying numbers of participants.

The media analysis module 210 may detect a number of participants 154-1-p present in each input media stream 204-1-f. The media analysis module 210 may detect a number of participants 154-1-p using various characteristics of the media content within the input media streams 204-1-f. In one embodiment, for example, the media analysis module 210 may detect a number of participants 154-1-p using image analysis techniques on video content from the input media streams 204-1-f. In one embodiment, for example, the media analysis module 210 may detect a number of participants 154-1-p using voice analysis techniques on audio content from the input media streams 204-1-f. In one embodiment, for example, the media analysis module 210 may detect a number of participants 154-1-p using both image analysis and voice analysis on audio content from the input media streams 204-1-f. Other types of media content may be used as well.

In one embodiment, the media analysis module 210 may detect a number of participants using image analysis on video content from the input media streams 204-1-f. For example, the media analysis module 210 may perform image analysis to detect certain characteristics of human beings using any common techniques designed to detect a human within an image or sequence of images. In one embodiment, for example, the media analysis module 210 may implement various types of face detection techniques. Face detection is a computer technology that determines the locations and sizes of human faces in arbitrary digital images. It detects facial features and ignores anything else, such as buildings, trees and bodies. The media analysis module 210 may be arranged to implement a face detection algorithm capable of detecting local visual features from patches that include distinguishable parts of a human face. When a face is detected, the media analysis module 210 may update an image counter indicating a number of participants detected for a given input media stream 204-1-f. The media analysis module 210 may then perform various optional post-processing operations on an image chunk with image content of the detected participant in preparation for face recognition operations. Examples of such post-processing operations may include extracting video content representing a face from the image or sequence of images, normalizing the extracted video content to a certain size (e.g., a 64×64 matrix), and uniformly quantizing the RGB color space (e.g., 64 colors). The media analysis module 210 may output an image counter value and each processed image chunk to the participant identification module 220.

In one embodiment, the media analysis module 210 may detect a number of participants using voice analysis on audio content from the input media streams 204-1-f. For example, the media analysis module 210 may perform voice analysis to detect certain characteristics of human speech using any common techniques designed to detect a human within an audio segment or sequence of audio segments. In one embodiment, for example, the media analysis module 210 may implement various types of voice or speech detection techniques. When a human voice is detected, the media analysis module 210 may update a voice counter indicating a number of participants detected for a given input media stream 204-1-f. The media analysis module 210 may optionally perform various post-processing operations on an audio chunk with audio content from the detected participant in preparation for voice recognition operations.

Once an audio chunk with audio content from a participant is identified, the media analysis module 210 may then identify an image chunk corresponding to the audio chunk. This may be accomplished, for example, by comparing time sequences for the audio chunk with time sequences for image chunks, comparing the audio chunk with lip movement from image chunks, and other audio/video matching techniques. For example, video content is typically captured as a number of media frames (e.g., still images) per second (typically on the order of 15-60 frames per second, although other rates may be used). These media frames 252-1-g, as well as the corresponding audio content (e.g., every 1/15 to 1/60 of a second of audio data) are used as the frame for location operations by the location module 232. When recording audio, the audio is typically sampled at a much higher rate than the video (e.g., while 15 to 60 images may be captured each second for video, thousands of audio samples may be captured). The audio samples may correspond to a particular video frame in a variety of different manners. For example, the audio samples ranging from when a video frame is captured to when the next video frame is captured may be the audio frame corresponding to that video frame. By way of another example, the audio samples centered about the time of the video capture frame may be the audio frame corresponding to that video frame. For example, if video is captured at 30 frames per second, the audio frame may range from 1/60 of a second before the video frame is captured to 1/60 of a second after the video frame is captured. In some situations the audio content may include data that does not directly correspond to the video content. For example, the audio content may be a soundtrack of music rather than the voices of participants in the video content. In these situations, the media analysis module 210 discards the audio content as a false positive, and reverts to face detection techniques.

In one embodiment, for example, the media analysis module 210 may detect a number of participants 154-1-p using both image analysis and voice analysis on audio content from the input media streams 204-1-f. For example, the media analysis 210 may perform image analysis to detect a number of participants 154-1-p as an initial pass, and then perform voice analysis to confirm detection of the number of participants 154-1-p as a subsequent pass. The use of multiple detection techniques may provide an enhanced benefit by improving accuracy of the detection operations, at the expense of consuming greater amounts of computing resources.

The participant identification module 220 may be arranged to map a meeting invitee to each detected participant. The participant identification module 220 may receive three inputs, including a meeting invitee list 202 from the enterprise resource directory 160, the media counter values (e.g., image counter value or voice counter value) from the media analysis module 210, and the media chunks (e.g., image chunk or audio chunk) from the media analysis module 210. The participant identification module 220 may then utilize a participant identification algorithm and one or more of the three inputs to map a meeting invitee to each detected participant.

As previously described, the meeting invitee list 202 may comprise a list of individuals invited to a multimedia conference event. In some cases, the meeting invitee list 202 may only include those individuals invited and accepted for the multimedia event. In addition, the meeting invitee list 202 may also include various types of information associated with a given meeting invitee. For example, the meeting invitee list 202 may include identifying information for a given meeting invitee, authentication information for a given meeting invitee, a meeting console identifier used by the meeting invitee, and so forth.

The participant identification algorithm may be designed to identify meeting participants relatively quickly using a threshold decision based on the media counter values. An example of pseudo-code for such a participant identification algorithm is shown as follows:

```
Receive meeting attendee list;
For each media stream:
  Detect a number of participants (N);
  If N = = 1 then participant is media source,
    Else if N > 1 then
        Query signature data store for meeting invitee information,
        Match signatures to media chunks;
End.
```

In accordance with the participant identification algorithm, the participant identification module 220 determines whether a number of participants in a first input media stream 204-1 equals one participant. If TRUE (e.g., N==1), the participant identification module 220 maps a meeting invitee from the meeting invitee list 202 to a participant in the first input media stream 204-1 based on a media source for the first input media stream 204-1. In this case, the media source for the first input media stream 204-1 may comprise one of the remote meeting consoles 110-2-m, as identified in the meeting invitee list 202 or the signature data store 260. Since there is only a single participant detected in the first input media stream 204-1, the participant identification algorithm assumes that the participant is not in the conference room 150, and therefore maps the participant in the media chunk directly to the media source. In this manner, the participant identification module 220 reduces or avoids the need to perform further analysis of the media chunks received from the media analysis module 210, thereby conserving computing resources.

In some cases, however, multiple participants may gather in a the conference room 150 and share various types of multimedia equipment coupled to a local meeting console 110-1 to communicate with other participants having remote meeting consoles 110-2-m. Since there is a single local meeting console 110-1, a single participant (e.g. participant 154-1) in the conference room 150 typically uses the local meeting console 110-1 to join a multimedia conference event on behalf of all the participants 154-2-p in the conference room 150. Consequently, the multimedia conferencing server 130 may have identifying information for the participant 154-1, but not have any identifying information for the other participants 154-2-p in the conference room 150.

To handle this scenario, the participant identification module 220 determines whether a number of participants in a second input media stream 204-2 equals more than one participant. If TRUE (e.g., N>1), the participant identification module 220 maps each meeting invitee to each participant in the second input media stream 204-2 based on face signatures, voice signatures, or a combination of face signatures and voice signatures.

As shown in FIG. 2, the participant identification module 220 may be communicatively coupled to a signature data store 262. The signature data store 262 may store meeting invitee information 262 for each meeting invitee in the meeting invitee list 202. For example, the meeting invitee information 262 may include various meeting invitee records corresponding to each meeting invitee in the meeting invitee list 202, with the meeting invitee records having meeting invitee identifiers 264-1-a, face signatures 266-1-b, voice signatures 268-1-c, and identifying information 270-1-d. The various types of information stored by the meeting invitee records may be derived from various sources, such as the meeting invitee list 202, the enterprise resource database 260, previous multimedia conference events, the meeting consoles 110-1-m, third party databases, or other network accessible resources.

In one embodiment, the participant identification module 220 may implement a facial recognition system arranged to perform face recognition for the participants based on face signatures 266-1-b. A facial recognition system is a computer application for automatically identifying or verifying a person from a digital image or a video media frame from a video source. One of the ways to do this is by comparing selected facial features from the image and a facial database. This can be accomplished using any number of face recognition systems, such as an eigenface system, a fisherface system, a hidden markov model system, a neuronal motivated dynamic link matching system, and so forth. The participant identification module 220 may receive the image chunks from the media analysis module 210, and extract various facial features from the image chunks. The participant identification module 220 may retrieve one or more face signatures 266-1-b from the signature data store 260. The face signatures 266-1-b may contain various facial features extracted from a known image of the participant. The participant identification module 220 may compare the facial features from the image chunks to the different face signatures 266-1-b, and determine whether there is a match. If there is a match, the participant identification module 220 may retrieve the identifying information 270-1-d that corresponds to the face signature 266-1-b, and output the media chunk and the identifying information 270-1-d to the media annotation module 230. For example, assume the facial features from an image chunk matches a face signature 266-1, then the participant identification module 220 may retrieve the identifying information 270-1 corresponding to the face signature 266-1, and output the media chunk and the identifying information 270-1 to the media annotation module 230.

In one embodiment, the participant identification module 220 may implement a voice recognition system arranged to perform voice recognition for the participants based on voice signatures 268-1-c. A voice recognition system is a computer application for automatically identifying or verifying a person from an audio segment or multiple audio segments. A voice recognition system may identify individuals based on their voices. A voice recognition system extracts various features from speech, models them, and uses them to recognize a person based on his/her voice. The participant identification module 220 may receive the audio chunks from the media analysis module 210, and extract various audio features from the image chunks. The participant identification module 220 may retrieve a voice signature 268-1-c from the signature data store 260. The voice signature 268-1-c may contain various speech or voice features extracted from a known speech or voice pattern of the participant. The participant identification module 220 may compare the audio features from the image chunks to the voice signature 268-1-c, and determine whether there is a match. If there is a match, the participant identification module 220 may retrieve the identifying information 270-1-d that corresponds to the voice signature 268-1-c, and output the corresponding image chunk and identifying information 270-1-d to the media annotation module 230.

The media annotation module 230 may be operative to annotate media frames 252-1-g of each input media stream 204-1-f with identifying information 270-1-d for each mapped participant within each input media stream 204-1-f to form a corresponding annotated media stream 205. For example, the media annotation module 230 receives the various image chunks and identifying information 270-1-d from the participant identification module 220. The media annotation module 230 then annotates one or more media frames 252-1-g with the identifying information 270-1-d in relatively close proximity to the mapped participant. The media annotation module 230 may determine precisely where to annotate the one or more media frames 252-1-g with the identifying information 270-1-d using location information received from the location module 232.

The location module 232 is communicatively coupled to the media annotation module 230 and the media analysis module 210, and is operative to determine location information for a mapped participant 154-1-p within a media frame or successive media frames 252-1-g of an input media stream 204-1-f. In one embodiment, for example, the location information may include a center coordinate 256 and boundary area 258 for the mapped participant 154-1-p.

The location module 232 manages and updates location information for each region in the media frames 252-1-g of an input media stream 204-1-f that includes, or potentially includes, a human face. The regions in the media frames 252-1-g may be derived from the image chunks output from the media analysis module 210. For example, the media analysis module 210 may output location information for each region in the media frames 252-1-g that are used to form the image chunks with detected participants. The location module 232 may maintain a list of image chunk identifiers for the image chunks, and associated location information for each image chunk within the media frames 252-1-g. Additionally or alternatively, the regions in the media frames 252-1-g may be derived natively by the location module 232 by analyzing the input media frames 204-1-f independently from the media analysis module 210.

In the illustrated example, the location information for each region is described by a center coordinate 256 and a boundary area 258. The regions of video content that include participant faces are defined by the center coordinate 256 and the boundary area 258. The center coordinate 256 represents the approximate center of the region, while boundary area 258 represents any geometric shape around the center coordinate. The geometric shape may have any desired size, and may vary according to a given participant 154-1-p. Examples of geometric shapes may include without limitation a rectangle, a circle, ellipse, triangle, pentagon, hexagon, or other free-form shapes. The boundary area 258 defines the region in the media frames 252-1-g that includes a face and is tracked by the location module 232.

The location information may further include an identifying location 272. The identifying location 272 may comprise a position within the boundary area 258 to annotate the identifying information 270-1-d. Identifying information 270-1-d for a mapped participant 154-1-p may be placed anywhere within the boundary area 258. In application, the identifying information 270-1-d should be sufficiently close to the mapped participant 154-1-p to facilitate a connection between video content for the participant 154-1-p and the identifying information 270-1-d for the participant 154-1-p from the perspective of a person viewing the media frames 252-1-g, while reducing or avoiding the possibility of partially or fully occluding the video content for the participant 154-1-p. The identifying location 272 may be a static location, or may dynamically vary according to factors such as a size of a participant 154-1-p, movement of a participant 154-1-p, changes in background objects in a media frame 252-1-g, and so forth.

Once the media annotation module 230 receives the various image chunks and identifying information 270-1-d from the participant identification module 220, the media annotation module 230 retrieves location information for the image chunk from the location module 232. The media annotation module 230 annotates one or more of the media frames 252-1-g of each input media stream 204-1-f with identifying information 270-1-d for each mapped participant within each input media stream 204-1-f based on the location information. By way of example, assume a media frame 252-1 may include participants 154-1, 154-2 and 154-3. Further assume the mapped participant is participant 154-2. The media annotation module 230 may receive the identifying information 270-2 from the participant identification module 220, and location information for a region within the media frame 252-1. The media annotation module 230 may then annotate media frame 252-1 of the second input media stream 204-2 with the identifying information 270-2 for the mapped participant 154-2 within the boundary area 258 around the center coordinate 256 at the identifying location 272. In the illustrated embodiment shown in FIG. 1, the boundary area 258 comprises a rectangular shape, and the media annotation module 230 positions the identifying information 270-2 at an identifying location 272 comprising the upper right hand corner of the boundary area 258 in a space between the video content for the participant 154-2 and the edge of the boundary area 258.

Once a region of the media frames 252-1-g has been annotated with identifying information 270-1-d for a mapped participant 154-1-p, the location module 232 may monitor and track movement of the participant 154-1-p for subsequent media frames 252-1-g of the input media streams 204-1-f using a tracking list. Once detected, the location module 232 tracks each of the identified regions for the mapped participants 154-1-p in a tracking list. The location module 232 uses various visual cues to track regions from frame-to-frame in the video content. Each of the faces in a region being tracked is an image of at least a portion of a person. Typically, people are able to move while the video content is being generated, such as to stand up, sit down, walk around, move while seated in their chair, and so forth. Rather than performing face detection in each media frame 252-1-g of the input media streams 204-1-f, the location module 232 tracks regions that include faces (once detected) from frame-to-frame, which is typically less computationally expensive than performing repeated face detection.

A media mixing module 240 may be communicatively coupled to the media annotation module 230. The media mixing module 240 may be arranged to receive multiple annotated media streams 205 from the media annotation module 230, and combine the multiple annotated media streams 205 into a mixed output media stream 260 for display by multiple meeting consoles 110-1-m. The media mixing module 240 may optionally utilize a buffer 242 and various delay modules to synchronize the various annotated media streams 205. The media mixing module 240 may be implemented as an MCU as part of the content-based annotation component 134. Additionally or alternatively, the media missing module 240 may be implemented as an MCU as part of the server meeting component 132 for the multimedia conferencing server 130.

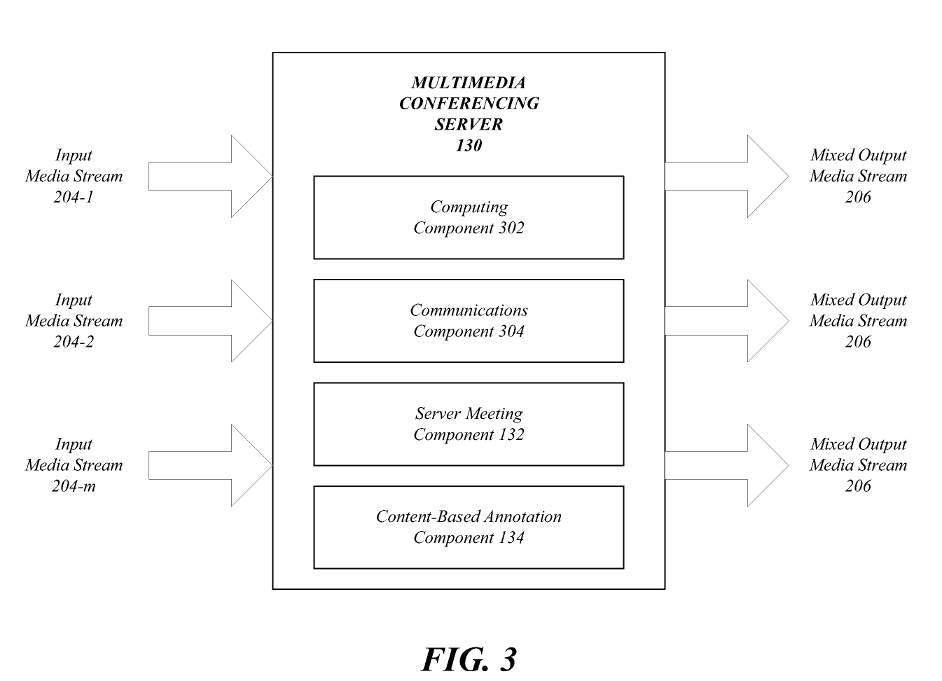

FIG. 3 illustrates a block diagram for the multimedia conferencing server 130. As shown in FIG. 3, the multimedia conferencing server 130 may receive various input media streams 204-1-m, process the various input media streams 204-1-m using the content-based annotation component 134, and output multiple mixed output media streams 206. The input media streams 204-1-m may represent different media streams originating from the various meeting consoles 110-1-m, and the mixed output media streams 206 may represent identical media streams terminating at the various meeting consoles 110-1-m.

The computing component 302 may represent various computing resources to support or implement the content-based annotation component 134. Examples for the computing component 302 may include without limitation processors, memory units, buses, chipsets, controllers, oscillators, system clocks, and other computing platform or system architecture equipment.

The communications component 304 may represent various communications resources to receive the input media streams 204-1-m and send the mixed output media streams 206. Examples for the communications component 304 may include without limitation receivers, transmitters, transceivers, network interfaces, network interface cards, radios, baseband processors, filters, amplifiers, modulators, demodulators, multiplexers, mixers, switches, antennas, protocol stacks, or other communications platform or system architecture equipment.

The server meeting component 132 may represent various multimedia conferencing resources to establish, manage or control a multimedia conferencing event. The server meeting component 132 may comprise, among other elements, a MCU. An MCU is a device commonly used to bridge multimedia conferencing connections. An MCU is typically an endpoint in a network that provides the capability for three or more meeting consoles 110-1-m and gateways to participate in a multipoint conference. The MCU typically comprises a multipoint controller (MC) and various multipoint processors (MPs). In one embodiment, for example, the server meeting component 132 may implement hardware and software for MICROSOFT OFFICE LIVE MEETING or MICROSOFT OFFICE COMMUNICATIONS SERVER. It may be appreciated, however, that implementations are not limited to these examples.

Operations for the above-described embodiments may be further described with reference to one or more logic flows. It may be appreciated that the representative logic flows do not necessarily have to be executed in the order presented, or in any particular order, unless otherwise indicated. Moreover, various activities described with respect to the logic flows can be executed in serial or parallel fashion. The logic flows may be implemented using one or more hardware elements and/or software elements of the described embodiments or alternative elements as desired for a given set of design and performance constraints. For example, the logic flows may be implemented as logic (e.g., computer program instructions) for execution by a logic device (e.g., a general-purpose or specific-purpose computer).

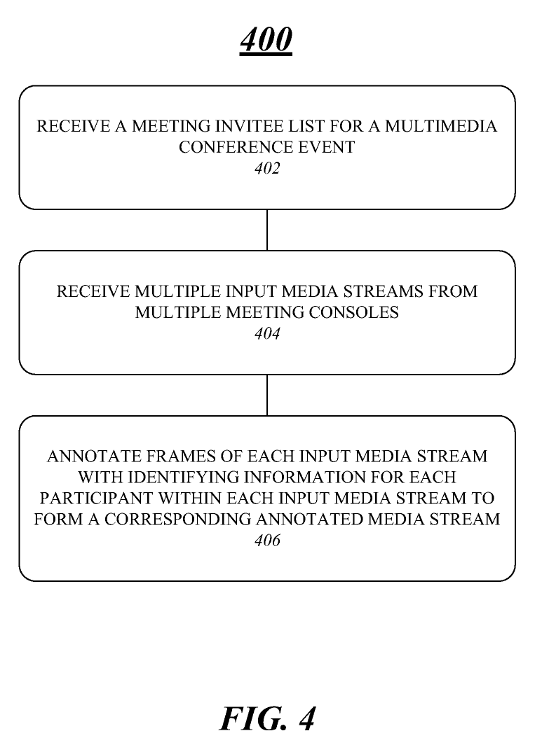

FIG. 4 illustrates one embodiment of a logic flow 400. Logic flow 400 may be representative of some or all of the operations executed by one or more embodiments described herein.

As shown in FIG. 4, the logic flow 400 may receive a meeting invitee list for a multimedia conference event 402. For example, the participant identification module 220 of the content-based annotation component 134 of the multimedia conferencing server 130 may receive the meeting invitee list 202 and accompanying information for a multimedia conference event. All or some of the meeting invitee list 220 and accompanying information may be received from the scheduling device 108 and/or the enterprise resource directory 160.

The logic flow 400 may receive multiple input media streams from multiple meeting consoles at block 404. For example, the media analysis module 210 may receive the input media streams 204-1-f, and output various image chunks with participants to the participant identification module 220. The participant identification module 220 may map the participants to a meeting invitee 264-1-a from the meeting invitee list 202 using the image chunks and various face recognition techniques and/or voice recognition techniques, and output the image chunks and corresponding identifying information 270-1-d to the media annotation module 230.

The logic flow 400 may annotate media frames of each input media stream with identifying information for each participant within each input media stream to form a corresponding annotated media stream at block 406. For example, the media annotation module 230 may receive the image chunks and corresponding identifying information 270-1-d from the participant identification module 220, retrieve location information corresponding to the image chunk from the location module 232, and annotate one or more media frames 252-1-g of each input media stream 204-1-f with identifying information 270-1-d for each participant 154-1-p within each input media stream 204-1-f to form a corresponding annotated media stream 205.

FIG. 5 further illustrates a more detailed block diagram of computing architecture 510 suitable for implementing the meeting consoles 110-1-m or the multimedia conferencing server 130. In a basic configuration, computing architecture 510 typically includes at least one processing unit 532 and memory 534. Memory 534 may be implemented using any machine-readable or computer-readable media capable of storing data, including both volatile and non-volatile memory. For example, memory 534 may include read-only memory (ROM), random-access memory (RAM), dynamic RAM (DRAM), Double-Data-Rate DRAM (DDRAM), synchronous DRAM (SDRAM), static RAM (SRAM), programmable ROM (PROM), erasable programmable ROM (EPROM), electrically erasable programmable ROM (EEPROM), flash memory, polymer memory such as ferroelectric polymer memory, ovonic memory, phase change or ferroelectric memory, silicon-oxide-nitride-oxide-silicon (SONOS) memory, magnetic or optical cards, or any other type of media suitable for storing information. As shown in FIG. 5, memory 534 may store various software programs, such as one or more application programs 536-1-t and accompanying data. Depending on the implementation, examples of application programs 536-1-t may include server meeting component 132, client meeting components 112-1-n, or content-based annotation component 134.

Computing architecture 510 may also have additional features and/or functionality beyond its basic configuration. For example, computing architecture 510 may include removable storage 538 and non-removable storage 540, which may also comprise various types of machine-readable or computer-readable media as previously described. Computing architecture 510 may also have one or more input devices 544 such as a keyboard, mouse, pen, voice input device, touch input device, measurement devices, sensors, and so forth. Computing architecture 510 may also include one or more output devices 542, such as displays, speakers, printers, and so forth.

Computing architecture 510 may further include one or more communications connections 546 that allow computing architecture 510 to communicate with other devices. Communications connections 546 may include various types of standard communication elements, such as one or more communications interfaces, network interfaces, network interface cards (NIC), radios, wireless transmitters/receivers (transceivers), wired and/or wireless communication media, physical connectors, and so forth. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired communications media and wireless communications media. Examples of wired communications media may include a wire, cable, metal leads, printed circuit boards (PCB), backplanes, switch fabrics, semiconductor material, twisted-pair wire, co-axial cable, fiber optics, a propagated signal, and so forth. Examples of wireless communications media may include acoustic, radio-frequency (RF) spectrum, infrared and other wireless media. The terms machine-readable media and computer-readable media as used herein are meant to include both storage media and communications media.

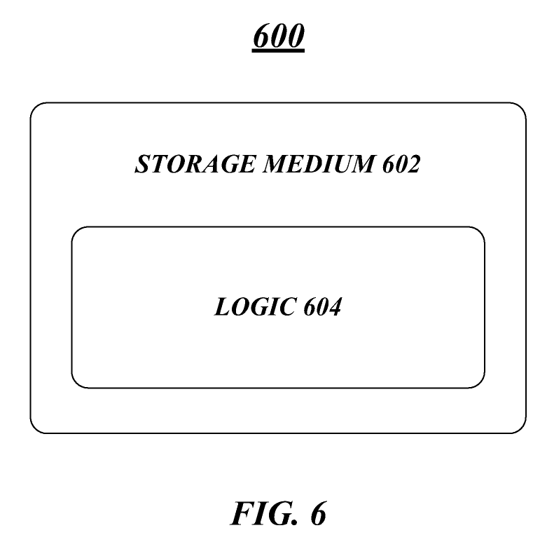

FIG. 6 illustrates a diagram an article of manufacture 600 suitable for storing logic for the various embodiments, including the logic flow 400. As shown, the article 600 may comprise a storage medium 602 to store logic 604. Examples of the storage medium 602 may include one or more types of computer-readable storage media capable of storing electronic data, including volatile memory or non-volatile memory, removable or non-removable memory, erasable or non-erasable memory, writeable or re-writeable memory, and so forth. Examples of the logic 604 may include various software elements, such as software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof.

In one embodiment, for example, the article 600 and/or the computer-readable storage medium 602 may store logic 604 comprising executable computer program instructions that, when executed by a computer, cause the computer to perform methods and/or operations in accordance with the described embodiments. The executable computer program instructions may include any suitable type of code, such as source code, compiled code, interpreted code, executable code, static code, dynamic code, and the like. The executable computer program instructions may be implemented according to a predefined computer language, manner or syntax, for instructing a computer to perform a certain function. The instructions may be implemented using any suitable high-level, low-level, object-oriented, visual, compiled and/or interpreted programming language, such as C, C++, Java, BASIC, Perl, Matlab, Pascal, Visual BASIC, assembly language, and others.

Various embodiments may be implemented using hardware elements, software elements, or a combination of both. Examples of hardware elements may include any of the examples as previously provided for a logic device, and further including microprocessors, circuits, circuit elements (e.g., transistors, resistors, capacitors, inductors, and so forth), integrated circuits, logic gates, registers, semiconductor device, chips, microchips, chip sets, and so forth. Examples of software elements may include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation.

Some embodiments may be described using the expression “coupled” and “connected” along with their derivatives. These terms are not necessarily intended as synonyms for each other. For example, some embodiments may be described using the terms “connected” and/or “coupled” to indicate that two or more elements are in direct physical or electrical contact with each other. The term “coupled,” however, may also mean that two or more elements are not in direct contact with each other, but yet still cooperate or interact with each other.

It is emphasized that the Abstract of the Disclosure is provided to comply with 37 C.F.R. Section 1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment. In the appended claims, the terms “including” and “in which” are used as the plain-English equivalents of the respective terms “comprising” and “wherein,” respectively. Moreover, the terms “first,” “second,” “third,” and so forth, are used merely as labels, and are not intended to impose numerical requirements on their objects.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. A method, comprising:
receiving a meeting invitee list for a multimedia conference event;
receiving multiple input media streams from multiple meeting consoles; and
annotating media frames of each input media stream with identifying information for each participant within each input media stream to form a corresponding annotated media stream.

2. The method of claim 1, comprising:
detecting a number of participants in each input media stream;
mapping a meeting invitee to each detected participant;
retrieving identifying information for each mapped participant; and
annotating media frames of each input media stream with identifying information for each mapped participant within each input media stream to form the corresponding annotated media stream.

3. The method of claim 2, comprising:
determining a number of participants in a first input media stream equals one participant; and
mapping a meeting invitee to a participant in the first input media stream based on a media source for the first input media stream.

4. The method of claim 2, comprising:
determining a number of participants in a second input media stream equals more than one participant; and
mapping a meeting invitee to a participant in the second input media stream based on face signatures or voice signatures.

5. The method of claim 2, comprising determining location information for a mapped participant within a media frame or successive media frames of an input media stream, the location information comprising a center coordinate and boundary area for the mapped participant.

6. The method of claim 2, comprising annotating media frames of each input media stream with identifying information for each mapped participant based on location information for each mapped participant.

7. The method of claim 2, comprising annotating media frames of each input media stream with identifying information for each mapped participant within a boundary area around a center coordinate for a determined location of the mapped participant.

8. The method of claim 2, comprising combining multiple annotated media streams into a mixed output media stream for display by multiple meeting consoles.

9. An article comprising a storage medium containing instructions that if executed enable a system to:
receive a meeting invitee list for a multimedia conference event;
receive multiple input media streams from multiple meeting consoles; and
annotate media frames of each input media stream with identifying information for each participant within each input media stream to form a corresponding annotated media stream.

10. The article of claim 9, further comprising instructions that if executed enable the system to:
detect a number of participants in each input media stream;
map a meeting invitee to each detected participant;
retrieve identifying information for each mapped participant; and
annotate media frames of each input media stream with identifying information for each mapped participant within each input media stream to form the corresponding annotated media stream.

11. The article of claim 9, further comprising instructions that if executed enable the system to:
determine a number of participants in a first input media stream equals one participant; and
map a meeting invitee to a participant in the first input media stream based on a media source for the first input media stream.

12. The article of claim 9, further comprising instructions that if executed enable the system to:
determine a number of participants in a second input media stream equals more than one participant; and
map a meeting invitee to a participant in the second input media stream based on face signatures or voice signatures.

13. An apparatus comprising a content-based annotation component operative to receive a meeting invitee list for a multimedia conference event, receive multiple input media streams from multiple meeting consoles, and annotate media frames of each input media stream with identifying information for each participant within each input media stream to form a corresponding annotated media stream.

14. The apparatus of claim 13, the content-based annotation component comprising:
a media analysis module operative to detect a number of participants in each input media stream;
a participant identification module communicatively coupled to the media analysis module, the participant identification module operative to map a meeting invitee to each detected participant, and retrieve identifying information for each mapped participant; and
a media annotation module communicatively coupled to the participant identification module, the media annotation module operative to annotate media frames of each input media stream with identifying information for each mapped participant within each input media stream to form the corresponding annotated media stream.

15. The apparatus of claim 14, the participant identification module operative to determine a number of participants in a first input media stream equals one participant, and map a meeting invitee to a participant in the first input media stream based on a media source for the first input media stream.

16. The apparatus of claim 14, the participant identification module operative to determine a number of participants in a second input media stream equals more than one participant, and map a meeting invitee to a participant in the second input media stream based on face signatures, voice signatures, or a combination of face signatures and voice signatures.

17. The apparatus of claim 14, comprising a location module communicatively coupled to the media annotation module, the location module operative to determine location information for a mapped participant within a media frame or successive media frames of an input media stream, the location information comprising a center coordinate and boundary area for the mapped participant.

18. The apparatus of claim 14, the media annotation module to annotate media frames of each input media stream with identifying information for each mapped participant based on location information.

19. The apparatus of claim 14, comprising a media mixing module communicatively coupled to the media annotation module, the media mixing module operative to receive multiple annotated media streams, and combine the multiple annotated media streams into a mixed output media stream for display by multiple meeting consoles.

20. The apparatus of claim 14, a multimedia conferencing server operative to manage multimedia conferencing operations for the multimedia conference event between the multiple meeting consoles, the multimedia conferencing server comprising the content-based annotation component.
